(19) United States
(12) Patent Application Publication
(10) Pub. No.: US 2011/0208324 A1
(43) Pub. Date: Aug. 25, 2011

(54) SYSYEM, METHOD, AND APPARATUS FOR MAINTENANCE OF SENSOR AND CONTROL SYSTEMS

(75) Inventor: Noriyasu FUKATSU, Chiyoda-ku (JP)

(73) Assignee: MITSUBISHI ELECTRIC CORPORATION, Tokyo (JP)

(21) Appl. No.: 12/712,823

(22) Filed: Feb. 25, 2010

(51) Int. Cl. G05B 19/05; G06F 1/28

(52) U.S. Cl. 700/7; 700/21

(57) ABSTRACT

An apparatus and method for providing maintenance of sensor and control systems is provided. A maintenance device coupled to a controller via a network backs up program-related information from the controller to a database via the network. The maintenance device determines when a malfunction occurs in the controller or a controller is replaced, and automatically restores backed up program-related information to the controller.

### BACKGROUND

1. Field of the Invention

Apparatuses and methods consistent with the present invention relate to providing automatic maintenance for sensor and control systems.

2. Description of the Related Art

In modern manufacturing facilities, automated processes are often controlled by low-level automation and process control and monitoring systems. Low-level automation systems may include dedicated robotic devices or other automated systems controlled or monitored by programmable logic controllers (PLCs). Various sensing devices and instrumentation may be used to monitor such processes, such as machine vision systems, barcode readers, or temperature sensors.

Often, a controller unit such as a PLC will fail or encounter problems, requiring an employee to replace the unit on the factory floor. In existing and previous systems, upon replacing the unit, an employee would be required to manually re-install the particular program software and related information required for the failed unit. In existing systems, such program information has been manually tracked by employees and manually re-installed, requiring costly human intervention and time. This manual process also is responsible for significant delays in restarting the assembly line, and for frequent human error in installing incorrect program information in a replacement unit. Furthermore, the latest version of the required program information is often not available, as back-ups are performed manually.

Existing and previous systems also require proprietary software applications, reducing the flexibility of these systems. Furthermore, network failures or failures of high-level management workstations in existing systems cause difficulties for performing a re-installation of the required program information.

### SUMMARY

Exemplary embodiments of the present invention address at least the above problems and/or disadvantages and other disadvantages not described above. Also, the present invention is not required to overcome the disadvantages described above, and an exemplary embodiment of the present invention may not overcome any of the problems listed above.

Accordingly to an exemplary embodiment, a maintenance controller operatively connected to a plurality of programmable logic controllers through a network is provided. The maintenance controller comprises a first controller; and a network interface module, wherein the maintenance controller is operatively connected to the network through the network interface module, the maintenance controller is operable to run a procedure for automatically requesting one of timestamp information and project information stored in each of the programmable logic controllers, from each of the plurality of programmable logic controllers, the maintenance controller is operable to receive and process a response from each of the plurality of programmable logic controllers, the response sent by the plurality of programmable logic controllers in response to the requesting by the maintenance controller, the maintenance controller is operable to automatically determine whether project information is stored in each of the plurality of programmable logic controllers based on the response from the plurality of programmable logic controllers, and the maintenance controlled is operable to automatically write previously stored project information to a first programmable logic controller from among the plurality of programmable logic controllers, if it is determined that the first programmable logic controller has no project information stored therein.

According to another exemplary embodiment, a method of monitoring the operation of a plurality of programmable logic controllers by a maintenance controller is provided. The method comprises automatically requesting one of timestamp information and project information stored in each of the plurality of programmable logic controllers, from each of the plurality of programmable logic controllers; receiving and processing a response from each of the plurality of programmable logic controllers, the response sent by the plurality of programmable logic controllers in response to the requesting; determining whether project information is stored in each of the plurality of programmable logic controllers based on the response from the plurality of programmable logic controllers; and automatically writing previously stored project information to a first programmable logic controller from among the plurality of programmable logic controllers, if it is determined that the first programmable logic controller has no project information stored therein.

According to another exemplary embodiment, a system including a plurality of programmable controllers and the maintenance controller is provided.

Due to the above-described features, employees on a manufacturing assembly line may easily swap out one controller device for another, as they are freed from having to manually set up the new controller device and its operating software. In this manner, an employee replacing a unit is also prevented from installing incorrect versions of program information.

The described features also reduce the work required of an assembly line supervisor, and reduce down-time due to swapping out malfunctioning controller devices, thereby increasing total system up-time.

When an employee replaces a unit, the system will also detect whether a different type of controller has been installed, and if so, issue a warning notification.

Finally, even in the event of the database, message queue, or network failure, the system does not interfere with replacement of the unit by an employee.

### BRIEF DESCRIPTION OF THE DRAWINGS

The above and/or other aspects of the present invention will be made more apparent by describing certain exemplary embodiments of the present invention with reference to the accompanying drawings, in which:

FIG. 1 illustrates an exemplary programmable logic controller.

FIG. 2 illustrates an exemplary system including a plurality of programmable logic controllers.

FIG. 3a illustrates an example of project information.

FIG. 3b illustrates an exemplary data structure stored in the database.

FIG. 4 illustrates an exemplary method of performing a backup operation and writing project information to a programmable logic controller.

FIGS. 5a and 5b illustrate an exemplary method for checking a status of the programmable logic controllers.

FIG. 6 illustrates an exemplary method for checking a controller type of the programmable logic controllers.

### DETAILED DESCRIPTION OF EXEMPLARY EMBODIMENTS

Certain exemplary embodiments of the present invention will now be described in greater detail with reference to the accompanying drawings.

In the following description, like drawing reference numerals are used for like elements, even in different drawings. The matters defined in the description, such as detailed construction and elements, are provided to assist in a comprehensive understanding of the invention. However, the present invention can be practiced without those specifically defined matters. Also, well-known functions or constructions are not described in detail since they would obscure the invention with unnecessary detail.

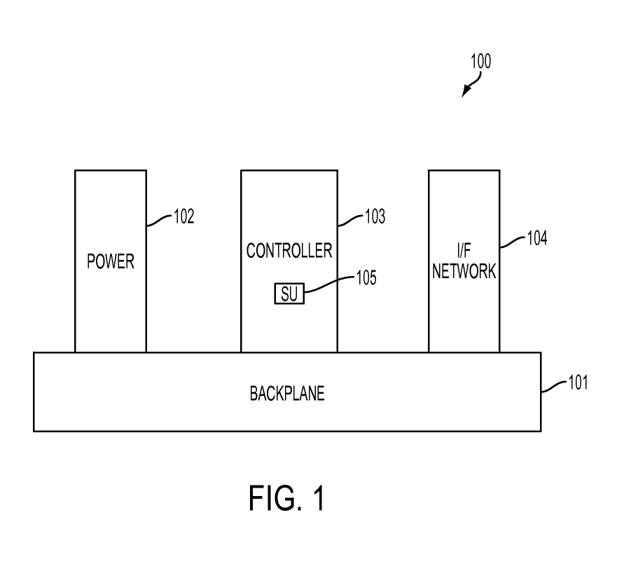

FIG. 1 is a block diagram illustrating a programmable logic controller (PLC) 100. The PLC 100 includes a power module 102 for obtaining energy from an outside power line which provides alternating current and for supplying power to the PLC 100. This power module 102 may include a capacitor or condenser which is charged by a voltage from the outer power line and supplies power to the PLC 100. The power module 102 may supply power to the PLC 100 for a predetermined period of short term power failure so that PLC 100 can maintain its function under an unstable power source environment. The power module 102 may be sufficiently charged within a small number of alternating current cycles such that the power module 102 can supply power to the PLC 100 even if short term power failure happens repeatedly over a short period. Hereinafter, the term “sufficiently charged” means charge/energy sufficient to supply power to the PLC 100 during the predetermined period of power failure. Such a feature may be beneficial in a manufacturing facility where devices are continuously added or removed so that it may be difficult to stabilize a power source. The predetermined period for which the power module 102 may use its energy storage components (the capacitor or the condenser) to supply power to the PLC 100 may vary and may range from half a cycle of alternating current to a number of alternating current cycles, depending on an energy storage capacity of the power module 102. The power module 102 may detect power failure of the outer power line. At that time, the power module 102 may send a power failure detection signal to PLC 100. By receiving the power failure detection signal, PLC 100 can prepare for an exception procedure for power failure. The PLC 100 further includes a controller 103 that performs the functions of the PLC 100. The controller 103 may further include a storage unit 105 for storing project information. The controller 103 controls the operation of the PLC based on the project information stored in a storage medium in the storage unit 105. The project information may be stored on any storage medium capable of storing the project information such that the project information can be updated anytime via different means such as carrier waves, RF signals, Ethernet signal, etc. A non-exhaustive list of the storage medium would include the following: an electrical connection having one or more wires, a portable computer diskette such as a floppy disk or a flexible disk, magnetic tape or any other magnetic medium, a hard disk, a random access memory (RAM), a read-only memory (ROM), an erasable programmable read-only memory (EPROM or Flash memory), a memory card, any other memory chip or cartridge, an optical fiber, a portable compact disc read-only memory (CD-ROM), any other optical medium, punch cards, paper tape, any other physical medium with patterns of holes, or any other medium from which a computer/controller can read or suitable combination of the foregoing. The project information may include information such as a date and time at which the project information was generated and an author of the project information. The project information is described in detail later.

The PLC 100 further includes a network interface module 104 through which the PLC 100 may communicate to a network. The network interface module 104 may include a network interface card coupled to a data bus. The network interface module 104 provides a two-way data communication coupling to a network link that may be connected to a local network. For example, 104 may be an integrated services digital network (ISDN) card or a modem to provide a data communication connection to a corresponding type of telephone line. As another example, 104 may be a local area network interface card (LAN NIC) to provide a data communication connection to a compatible LAN. Wireless links, such as well-known 802.11a, 802.11b, 802.11g and Bluetooth may also be used for network implementation. In any such implementation, the network interface module 104 sends and receives electrical, electromagnetic or optical signals that carry digital/analog data streams representing various types of information.

The PLC 100 further includes a backplane 101 through which the different modules are connected and communicate with each other. It will be obvious to one of ordinary skill in the art that a plurality of controllers 103 may be mounted on a single backplane 101 and that the complete PLC 100 may be powered by a single power module 102.

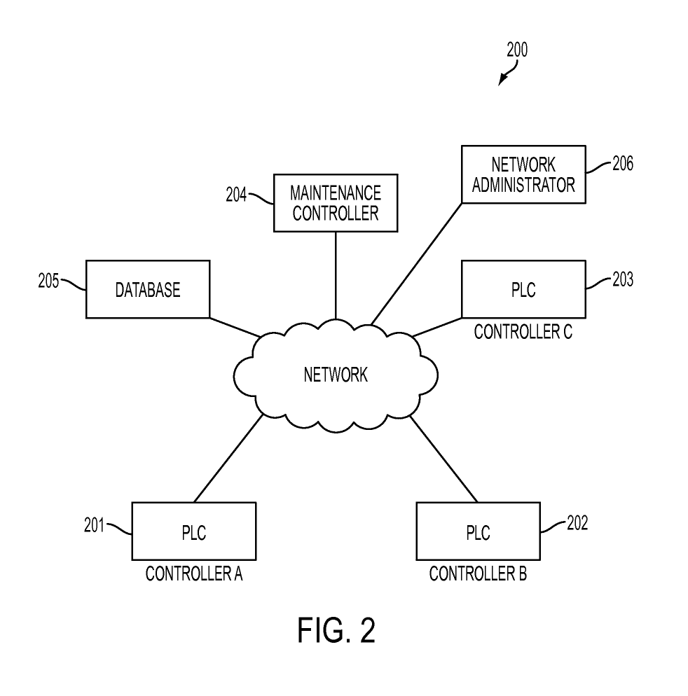

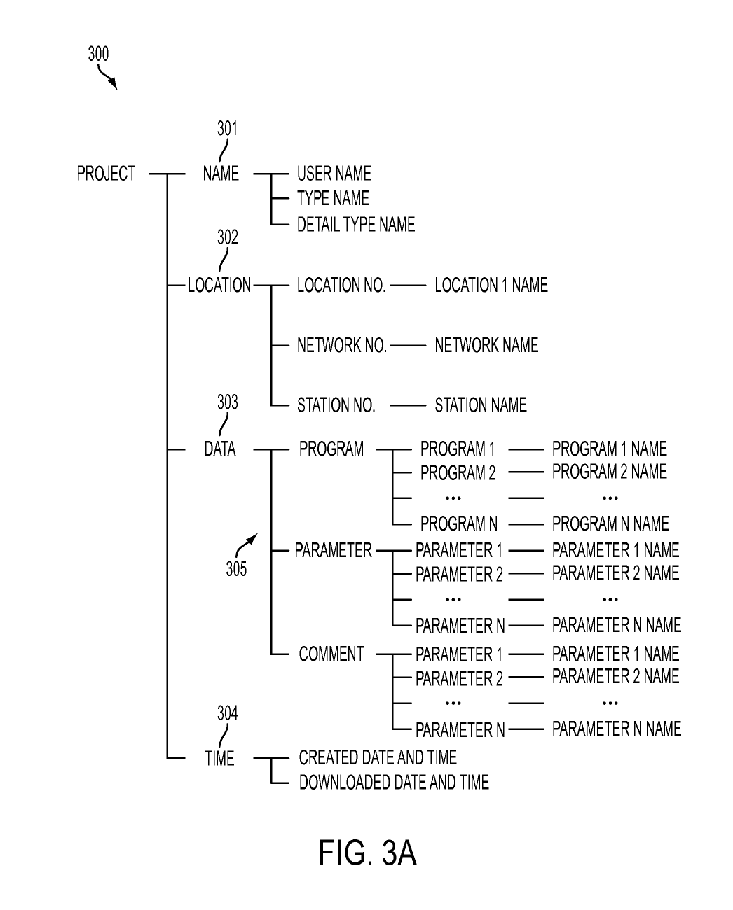

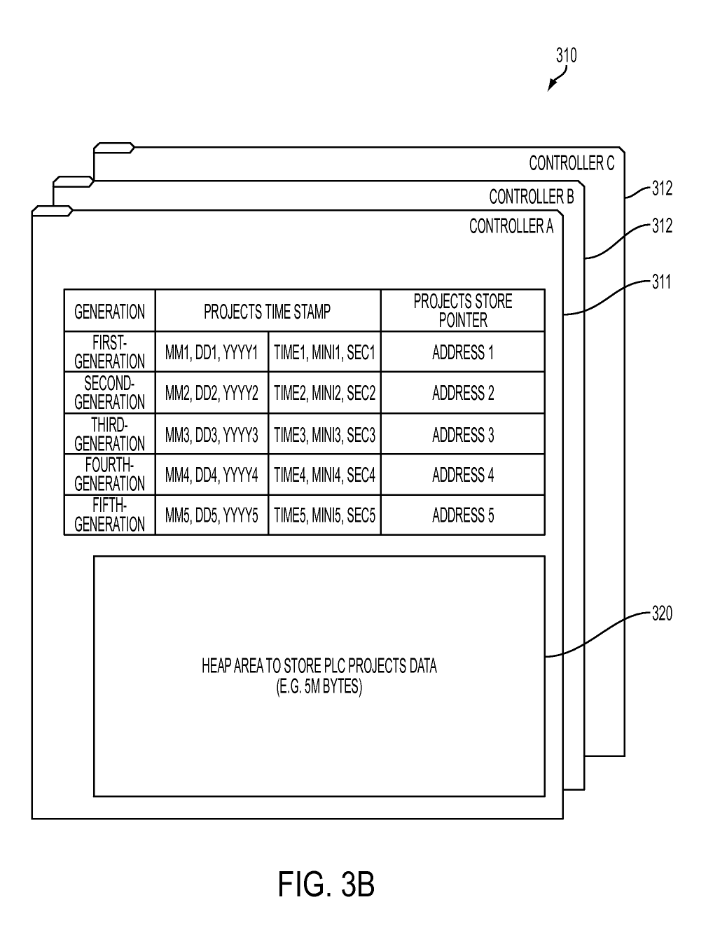

FIG. 2 illustrates an exemplary system 200 that includes a plurality of PLCs, a maintenance controller 204, a network administrator workstation 206, and a database 205 connected through a network. Three PLCs 201, 202, and 203 are shown exemplarily. It will be obvious that the number three is only for purposes of example and any number of PLCs may be connected in the system 200. The maintenance controller 204 is responsible for a plurality of functions such as keeping track of the latest version of the project information stored on each of the PLCs, updating the project information on each of the PLCs based on the latest project information stored in the database 205, etc. The maintenance controller (MC) 204 may have a structure similar to the exemplary PLC 100 structure illustrated in FIG. 1. The network administrator 206 corresponds to a manned/unmanned workstation that supervises the smooth functioning of the system 200. Next, the project information will be described in detail with reference to FIG. 3a.

FIG. 3a illustrates exemplary project information stored in the database (DB) 205 and the MC 204. A project 300 may include different components such as a name 301 of the controller corresponding to the project 300. The name 301 may include further information such as a user name of the corresponding controller. The user name may be provided by the operator/user of the system. As an example, the user name of the controller in PLC 201 may be controller A as shown in FIG. 2. The name 301 may further include a type name that specifies a controller type. For example, a model name of the controller may be Q02HX or Q02HY. Therefore, the controller may be from a series of PLCs that start with Q02H. The controller type may be Q02H as an example. Further, a detail type name may be the actual controller name, i.e., Q02HX.

The project information may further include location information 302 on the location of the controller. The location information 302 may include information on a Location No. such a slot number (for example slot #0) of the controller A on the backplane of the PLC. The Location No. may also have an associated Location Name stored, for example a Location Name for the slot #0 may be “Slot Zero”. The location information 302 may further include a Network no. with which the PLCs are connected to the MC 204. The Network No. may be further identified by a Network Name. The location information 302 may further include a Station No. that identifies the particular backplane or network interface module of the PLC corresponding to the Name 301. The Station No. may further have a specific Station Name.

The project information further includes Data 303. The Data 303 may include program information 305 based on which the controller carries out its intended operation. The program information 305 may include a plurality of programs that include ladder logic code. The program information 305 may further include the different parameters and corresponding parameter names. Comments corresponding to the parameters may also be included.

The project information 300 may further include time information 304. Time information 304 may include a time stamp that may define the time at which the project information 300 was created and a time at which the project information 304 was downloaded to the PLC 201. The time stamp may be of the form “MM,DD,YYY,Time,Min,Sec”. Time in the time stamp may correspond to the hour, Min may correspond to the minute, and Sec may correspond to the second of the timestamp.

FIG. 3b illustrates a sample data structure 310 stored in the DB 205. The data structure 301 helps keep track of the latest project information stored in a specific controller. Projects may be differentiated by their respective timestamps. For example, 311 is a graphical illustration of the data stored for Controller A (PLC 201). The data 311 includes pointers to the different generations of project information for controller A. The fifth-generation (or the highest generation) for controller A's project should have the latest timestamp. A project's timestamp may change when a change is made to the project's content. Therefore, if a maintenance person installed an updated project (with one of the programs changed) in controller A, the timestamp of the project information stored in controller A will be different from an earlier time stamp of the previous project information. The updated project may be stored as the latest project generation in the DB 205, i.e., the latest project is stored as the 5^{th} generation project in the DB 205. The data 311 may also have a heap area 320 to store the actual PLC project data, i.e., the plurality of programs, parameters, etc.

The MC 204 stores at least the latest project information for each of the PLCs (and each of its controllers if the PLC has more than one controller) that it is monitoring. The MC 204 may store the latest project information (for example, 5^{th} generation) in internal storage 105.

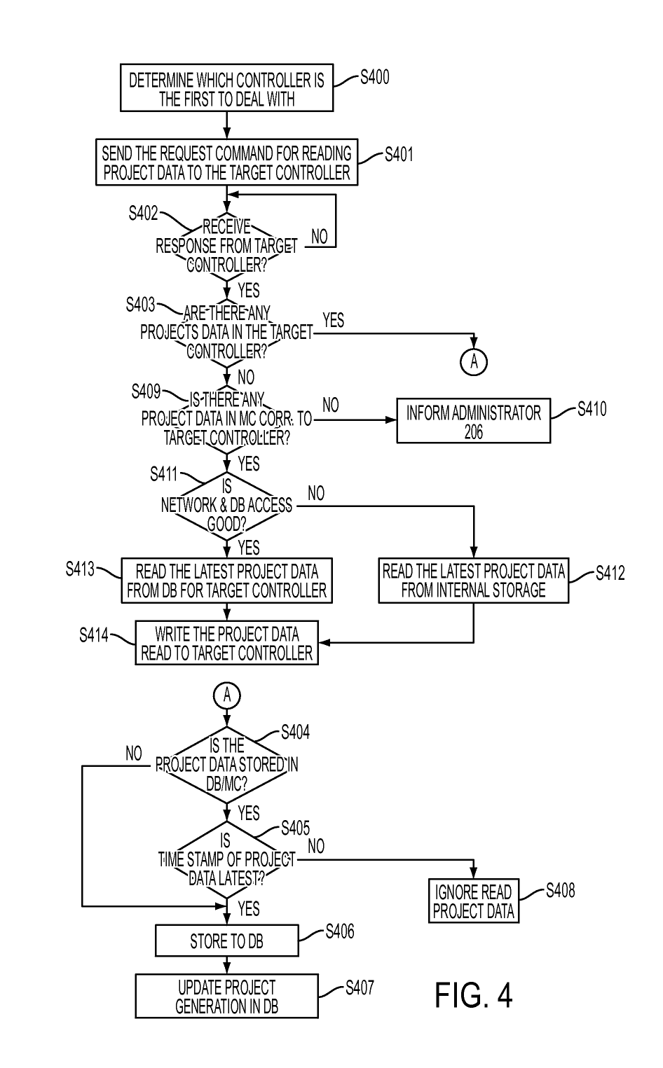

FIG. 4 is a flow chart depicting the operation of MC 204 and its interaction with other components of the system according to an exemplary embodiment of the invention. The process begins with an attempt by the MC 204 to determine which controller to read project information from (S400) first. In order to do that, MC 204 may check if any incomplete project information is stored in DB 205. Incomplete project information may be created when a network error occurs while receiving project information. As mentioned earlier, a manufacturing facility is often operated under an unstable power source environment. Although the present PLCs include power modules which enable the PLCs to endure a short term power failure, an unrecoverable power failure may still occur. To detect whether DB 205 stores incomplete project information, project information may be coded by using parities or error correction coding. Also, for the purpose of detecting whether incomplete project information is stored, validation flags may be used. The validation flags may be stored in the DB 205 in association with project information for each PLC. If the power modules of PLCs are designed to send a power failure detection signal to their PLCs when a power failure was detected, a PLC may send a special signal to the MC 204 on detection of power failure so that the MC 204 changes the validation flag for that PLC to an “OFF” state while the MC 204 may maintain the validation flag in an “ON” state in other cases. If the validation flag of a PLC is “OFF”, the project information of this PLC is incomplete or not properly stored in DB 205. By checking for any validation flags in “OFF” state in DB 205, the MC 204 may detect if it has any PLCs whose project information is incomplete in the DB 205.

Additionally, the validation flag may also be stored in the storage unit of PLCs. If the validation flag is stored in the storage unit of the PLCs and a PLC detects power failure, the power module of the PLC may send a power failure detection signal to the PLC (PLC controller) so that the PLC switches the flag to an “OFF”. When MC 204 needs to check whether any project information is incomplete, MC 204 may query the value of validation flags to each PLC via network so that MC 204 can determine if there are any PLCs with incomplete project information. The validation flags may be set to “ON” once the backup of project information finishes successfully.

Once the MC 204 determines that a particular PLC has incomplete project information stored in the database, the MC 204 reads project information from the particular PLC first. Assuming that a validation flag is “OFF” for controller A in PLC 201, the remaining process of FIG. 4 is further described. MC 204 sends a request (S401) to controller A (target controller) to send its project data. The MC 204 sends this request by transmitting the request to its network interface module which transmits that request to the network interface module of the controller A through the network as shown in FIG. 2. The MC 204 waits till it receives a response from the controller A (S402). The MC 204 may implement a timer for keeping track of the time the controller A takes to respond to the request. The MC 204 may inform the administrator 206 if the controller A does not respond within a predetermined time and the timer times out. If the MC 204 receives a response from controller A, the MC 204 determines whether there is any project data stored in the controller A (S403). It should be noted that the response from the controller A may include only a time stamp information of its currently stored project or the controller A may send the entire project data to the MC 204. The MC 204 may send the request (S401) to only a specific controller A (controller A of PLC 201 in this exemplary embodiment). Alternatively, the MC 204 may send the request (S401) to all the PLCs (to all the controllers) it is monitoring. In response, the PLCs (their controllers) may send their timestamps in addition to their identification (Name 301) and location information (location 302). Alternatively, controller A or all the controllers may respond with their complete project information.

If the MC 204 determines in S403 that the project information is indeed stored in controller A (this determination can be made by checking whether a time stamp is received from the controller A or if the MC 204 receives actual project information stored in the controller A), the MC 204 checks (S404) if its internal storage 105 and the DB 205 include any project information for the particular controller A. This step may be carried out by looking for the location information sent by the controller A in the internal storage 205 and/or in the DB 205. S404 may also be carried out by searching for the name information 301 sent by the controller A, in the internal storage 205 and/or in the DB 205.

If it is determined in S404 that the project data is stored in the internal storage and the DB 205, then time stamp of the latest generation of project data stored in the MC 204 and the DB 205 is checked for controller A (S505). If the time stamp information received from controller A is newer than the time stamp information currently stored in the DB 205 and MC 204, the project information is read from the controller A (assuming that controller A did not send the project information in the first place and only sent the time stamp information) and stored in the DB 205 and the MC 204 in S406. As the MC 204 may only store the latest project information in its internal storage 105, the MC 204 may replace the old project information for controller A with the latest project information of controller A in its internal storage 201. Furthermore, the DB 205 may update (S407) its listing of the project generation information if a newer project is found in controller A, i.e., the first generation may be discarded and the second generation will become the first generation and so on.

If in S404 it is determined that controller A includes project information and the DB 205 and MC 204 do not include any project information for controller A, the process proceeds directly to S406 in which the project information read from the controller A is written to the DB 205 and MC 204. Such an exemplary case may occur when a new controller (PLC 201) is installed and it has a project already loaded on it. Such a case may also occur if the project information stored in the controller A has been updated on the factory floor.

Furthermore, if it is determined that in S405 the time stamp received from the controller A is not newer than the time stamp currently stored in MC 204, the MC 204 discards (S408) the read project information or may not read the project information from controller A.

Going back to S403, if the MC 204 determines that no project information is stored in controller A (for example, no time stamp may be received from the controller A), the MC 204 checks (S409) whether any project information is stored in the MC 204 for controller A. This checking may be performed by searching for project information stored in the MC 204 internal storage 105 for the location information received from controller A. If in S409, it is determined that no project data is stored in the MC 204 for the location information corresponding to controller A, the Administrator 206 is informed in S410 that a new controller has been installed and no project information exists for it in the DB 205/MC 204. The DB 205 and MC 204 may be synchronized such that changes to the latest generation of project information stored in the DB 205 are automatically reflected in the project information stored in MC 204. Therefore, the MC 204 may not need to check the project information in DB 205 if no project information is found in the MC 204.

However, if it is determined in S409 that there is project information stored in the MC 204 (and therefore, in the DB 205) for the location corresponding to controller A, it is next checked whether network and DB access are good. If the network access to the DB is not good, the MC 204 reads (S412) the latest project information from its internal storage 105 and writes the project information read to controller A. If the network access to the DB 205 is determined to be good in S411, the project information is read from DB 205 (S413) and written to controller A (S414). Alternatively, the MC 204 may completely skip S411 and directly go through S412 and S414 after it is determined in S409 that the MC 204 has project information stored for controller A.

The steps 409 through S414 illustrate an automatic checking and project information writing process through which the latest project information is written to a controller. Such a scenario may occur when a PLC/controller failure occurs and the PLC/controller is replaced by a new PLC/controller that does not have any project information. As mentioned above, the location information is communicated to the MC 204 by the controller A in response to the request in S401. When a controller is new and no project information is stored on it, the location information may still be sent to the MC 204 as the location information may be stored in a separate register or some other hardware device in the PLC 201/controller A. For example, the network interface module may have a specific address which may correspond to the location information of the controller A.

The above procedure of FIG. 4 provides for an easy backup solution that enhances traceability of the project information and allows for easy installation of project information when a new controller is installed. It will be understood that the process of FIG. 4 may be run periodically on a preset schedule and may be run whenever desired by the administrator 206.

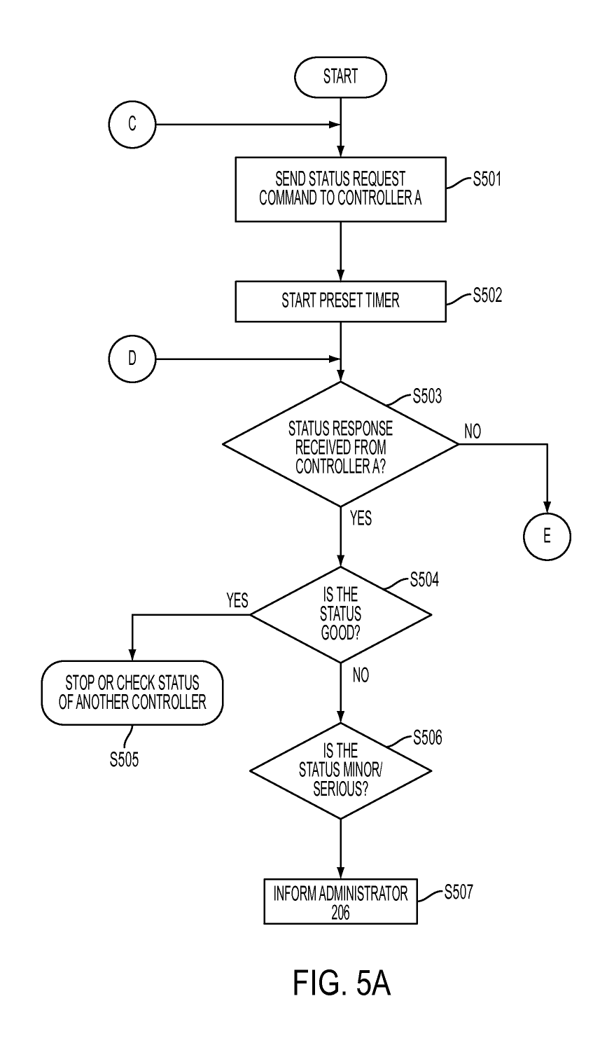

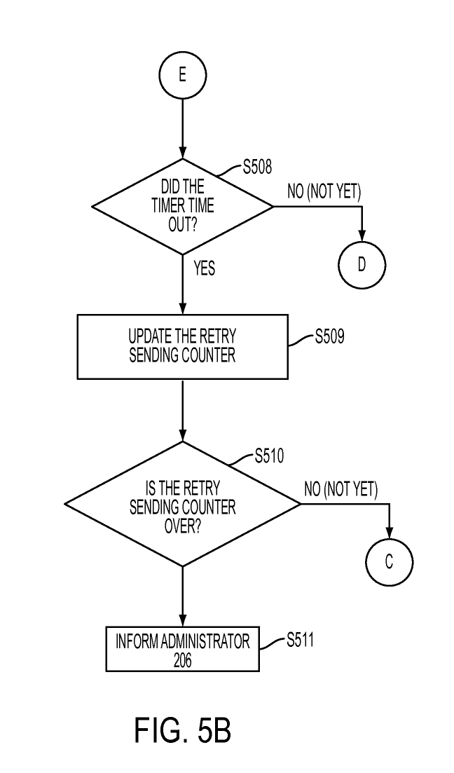

FIGS. 5a and 5b illustrate an exemplary embodiment for checking a status of the PLCs 201, 202, and 203. The MC 204 is responsible for checking the status of the PLCs. The MC 204 may run a program at a preset time through which the status check is performed. The MC 204 may be configured to run the status check program automatically at a preset time every day or it may be manually controlled by an administrator either through the network or manually to run the status check program. The maintenance controller (MC) selects a first PLC (for example 201) to check the status. The maintenance controller may check the status of each of the PLCs at the same time or it may check the status of each of them sequentially.

Assuming that the MC 204 is checking the status of PLC 201, the first step S501 may be to send a status request command to the PLC 201 (more specifically to a controller A in the PLC 201). In S502, the MC 204 may start a preset timer in response to sending the status request command. The status request command may be sent through the network. In response to the status request command, the PLC 201 may send a status response or may not send a status response. The PLC 201 may send a status response by checking an internal register that is set by its controller depending on a variety of conditions. In S503, it is determined whether a status response was received by the MC 204. If a response was received from the PLC 201, it is checked in S504 whether the status response indicated a good condition or a bad condition (serious/minor). If the response was good, then in S505 the MC 204 stops the status check or checks the status of another PLC. The MC 204 may also record the status response in its database for the specific PLC whose status was checked. In S506, it is determined whether the status response was bad and if bad was it minor or serious. In both cases an administrator 206 is informed in S507.

However, if a status response is not received from the PLC 201, then the MC 204 waits for a predetermined time and checks whether the timer timed out in S508. If the timer did not time out, then the MC 204 waits for the status response from the PLC 201. If the timer has timed out and the status response has yet been received, the MC 204 updates a retry sending counter in S509. The retry sending counter is a counter that keeps track of the number of times the MC 204 may reset the timer and try the status request check again for the PLC 201. For example, the MC 204 may try the status check process illustrated in FIGS. 5a and 5b five times (check if the retry sending counter has exceeded its limit in S510) before it informs the administrator in S511. If the retry sending counter 510 has not exceeded its limit, the MC 204 restarts the process from S501.

The above process of FIGS. 5a and 5b establishes an automated procedure of checking the health of the PLCs and generating an automatic notification to the administrator if one of the PLCs becomes defective. In the above process the status request is sent to the PLC. It will be understood that the status request is received by the controller in the PLC, and the controller responds to the status request through the network interface module of the PLC.

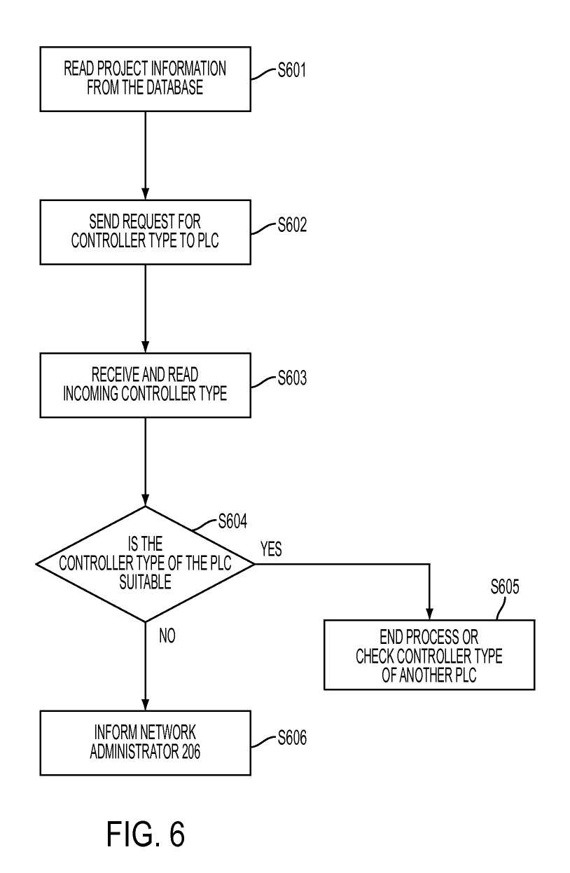

Next, an exemplary process of reading and checking a controller type is illustrated with reference to FIG. 6. In S601, the MC 204 reads project information for a specific PLC (more specifically for a specific controller in the specific PLC). Say for example, the MC 204 wants to check a controller type for the controller A in PLC 201. The MC 204 reads the project information for controller A from its internal storage 105 or the DB 205 and sends a request (S602) to the controller A to send its controller type. The controller A looks up its controller type from the project information it has stored therein and sends the controller type information to the MC 204 (S603). Specifically, the controller A may send name information 300 that includes the type name and the detail type name. In response, the MC 204 checks (S604) whether the controller A is a suitable controller type. The MC 204 may determine this by comparing the type name received from controller A with the type name in the project information read from the DB 205 or internally stored in MC 205. The MC 204 may inform the administrator 206 if the controller A is not of suitable controller type in S606. If the controller A is determined to be of suitable controller type, the process is either ended or a controller type of another PLC controller is checked.

The above process is useful because the MC 204 may quickly determine that an incorrect controller not suitable for operation of a particular PLC has been installed.

Furthermore, in the exemplary embodiments described above, the maintenance controller may be configured to control a resetting or restarting of the PLC controllers remotely. Such an action may be accomplished by the MC sending a remote run request to the controllers in the PLCs. Furthermore, the MC 204 may keep an action log of the operations of the PLC.

Exemplary embodiments described above have the following salient features. During normal operation, backups of data necessary for operation of the controller can be performed at a timing specified by a user. The backup data may be stored in a database for easy retrieval later. If a failure occurs in the controller and there is a need for replacement of the controller, the backup data may be quickly written to the new controller without manual intervention.

The present disclosure may simplify the unit replacement operation for operators at production sites. Further, it may reduce the work of supervisors at production sites. It may also reduce down-time due to unit replacement and increase system up-time. If controller failure occurs and the situation requires replacement of H/W, site operators can restart the system in a short time simply by installing a new controller in the system. Further, the present disclosure may alleviate the need to operate a personal computer or install a backup memory card just to download the control program to the controller. When the PLC/controller is rebooted after controller replacement, the maintenance controller checks the status of the controller, the optimal (newest) control program for that controller is retrieved from the memory space managed by the maintenance controller and downloaded to the controller, and the controller is reset and placed into operation. Another advantage is that an on-site operator is freed from the trouble of confirming the combination of controller and control program during the unit replacement operation. This may eliminate mistaken download of a different control program by the on-site operator during the unit replacement operation.

If by chance, the on-site operator mistakenly installs a different controller in the system during the unit replacement operation, that fact is detected and a warning is issued.

The unit replacement operation by the on-site operator is not hindered if the higher level DB or message queue is not operational for some reason.

Furthermore, each of the processes described in FIGS. 4-6 may be implemented by a special purpose computer operating in accordance with instructions stored on a tangible computer-readable storage medium.

The foregoing exemplary embodiments are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

1. A maintenance controller operatively connected to a plurality of programmable logic controllers through a network, the maintenance controller comprising:
a first controller; and
a network interface module,
wherein:
the maintenance controller is operatively connected to the network through the network interface module,
the maintenance controller is operable to run a procedure for automatically requesting one of timestamp information and project information stored in each of the programmable logic controllers, from each of the plurality of programmable logic controllers,
the maintenance controller is operable to receive and process a response from each of the plurality of programmable logic controllers, the response sent by the plurality of programmable logic controllers in response to the requesting by the maintenance controller,
the maintenance controller is operable to automatically determine whether project information is stored in each of the plurality of programmable logic controllers based on the response from the plurality of programmable logic controllers, and
the maintenance controller is operable to automatically write previously stored project information to a first programmable logic controller from among the plurality of programmable logic controllers, if it is determined that the first programmable logic controller has no project information stored therein.

2. The maintenance controller of claim 1, wherein the maintenance controller is further operable to check an operating status of each of the plurality of programmable logic controllers and is operable to inform an administrator if a predetermined operating status is detected.

3. The maintenance controller of claim 1, wherein the maintenance controller is operatively connected to a database, which is configured to store a plurality of generations of the project information stored in each of the plurality of programmable logic controllers.

4. The maintenance controller of claim 3, wherein the project information of each of the plurality of programmable logic controllers includes information on a controller type of the programmable logic controller, the time stamp of the project information, and location information of the controller of the programmable logic controller.

5. The maintenance controller of claim 4, wherein the maintenance controller is operable to update project information stored in the database for the first programmable logic controller if the time stamp information received from the first programmable logic controller is newer than the time stamp information stored in the database for the first programmable logic controller.

6. The maintenance controller of claim 4, wherein the maintenance controller determines that the first programmable logic controller has no project information stored therein if no time stamp information is received from the programmable logic controller in response to the requesting of time stamp information by the maintenance controller.

7. A method of monitoring the operation of a plurality of programmable logic controllers by a maintenance controller, the method comprising:
automatically requesting one of timestamp information and project information stored in each of the plurality of programmable logic controllers, from each of the plurality of programmable logic controllers;
receiving and processing a response from each of the plurality of programmable logic controllers, the response sent by the plurality of programmable logic controllers in response to the requesting;
determining whether project information is stored in each of the plurality of programmable logic controllers based on the response from the plurality of programmable logic controllers; and
automatically writing previously stored project information to a first programmable logic controller from among the plurality of programmable logic controllers, if it is determined that the first programmable logic controller has no project information stored therein.

8. The method of claim 7, further comprising automatically checking an operating status of each of the plurality of programmable logic controllers and informing an administrator if a predetermined operating status is detected.

9. The method of claim 7, wherein the maintenance controller is operatively connected to a database, which is configured to store a plurality of generations of the project information stored in each of the plurality of programmable logic controllers.

10. The method of claim 9, wherein the project information of each of the plurality of programmable logic controllers includes information on a controller type of the programmable logic controller, the time stamp of the project information, and location information of the controller of the programmable logic controller.

11. The method of claim 10, further comprising updating project information stored in the database for the first programmable logic controller if the time stamp information received from the first programmable logic controller is newer than the time stamp information stored in the database for the first programmable logic controller.

12. The method of claim 10, wherein the maintenance controller determines that the first programmable logic controller has no project information stored therein if no time stamp information is received from the programmable logic controller in response to the requesting of time stamp information by the maintenance controller.

13. A system comprising:
a plurality of programmable logic controllers; and
a maintenance controller including a network interface module, and operatively connected to the plurality of programmable logic controllers through a network,
wherein:
the maintenance controller is operatively connected to the network through the network interface module,
the maintenance controller is operable to run a procedure for automatically requesting one of timestamp information and project information stored in each of the programmable logic controllers, from each of the plurality of programmable logic controllers,
the maintenance controller is operable to receive and process a response from each of the plurality of programmable logic controllers, the response sent by the plurality of programmable logic controllers in response to the requesting by the maintenance controller,
the maintenance controller is operable to automatically determine whether project information is stored in each of the plurality of programmable logic controllers based on the response from the plurality of programmable logic controllers, and
the maintenance controller is operable to automatically write previously stored project information to a first programmable logic controller from among the plurality of programmable logic controllers, if it is determined that the first programmable logic controller has no project information stored therein.

14. The system of claim 13, wherein each of the programmable logic controllers include a power module, a network interface module, and a controller.

15. The system of claim 14, wherein:
the power module is operable to send a power failure detection signal to the controller of the programmable logic controller, in response to a power failure,
a validation flag status is set based on the power failure detection signal, and
the maintenance controller determines that incomplete project information is stored for the programmable logic controller whose validation flag status is set.

16. The system of claim 13, wherein the maintenance controller is further operable to check an operating status of each of the plurality of programmable logic controllers and is operable to inform an administrator if a predetermined operating status is detected.

17. The system of claim 13, wherein the maintenance controller is operatively connected to a database, which is configured to store a plurality of generations of the project information stored in each of the plurality of programmable logic controllers.

18. The system of claim 17, wherein the project information of each of the plurality of programmable logic controllers includes information on a controller type of the programmable logic controller, the time stamp of the project information, and location information of the controller of the programmable logic controller.

19. The system of claim 18, wherein the maintenance controller is operable to update project information stored in the database for the first programmable logic controller if the time stamp information received from the first programmable logic controller is newer than the time stamp information stored in the database for the first programmable logic controller.

20. The system of claim 18, wherein the maintenance controller determines that the first programmable logic controller has no project information stored therein if no time stamp information is received from the programmable logic controller in response to the requesting of time stamp information by the maintenance controller.
